(19) United States
(12) Patent Application Publication
(10) Pub. No.: US 2007/0190224 A1
(43) Pub. Date: Aug. 16, 2007

(54) Ruminant feed production methods and systems

(75) Inventors: George Betton, Millsboro, DE (US); Normand St. Pierre, Columbus, OH (US)

Correspondence Address: RATNERPRESTIA, P.O. BOX 980, VALLEY FORGE, PA, 19482-0980, US

(73) Assignee: Venture Milling, Inc.

(21) Appl. No.: 11/479,499

(22) Filed: Jun. 30, 2006

Related U.S. Application Data
(60) Provisional application No. 60/773,426, filed on Feb. 15, 2006.

(51) Int. Cl. G06F 19/00; A23K 1/00

(52) U.S. Cl. 426/635; 436/86; 702/19

(57) ABSTRACT

Methods, systems, and computer program products for use in producing feed for a ruminant utilize information about sources of blood meal to provide a formulation for an optimum and cost-effective feed. The ruminant feed has a minimum metabolizable nutrient level for at least one nutrient, e.g., protein. Ruminant feed may be produced by determining a metabolizable nutrient level in a low quality blood meal and determining a quantity of low quality blood meal for blending with a quantity of a high quality blood meal having a second metabolizable nutrient level to produce the ruminant feed having the minimum metabolizable nutrient level.

### CROSS REFERENCE TO RELATED APPLICATIONS

This application claims the benefit of the filing date of U.S. Provisional Application Ser. No. 60/773,426 entitled “RUMINANT FEED PRODUCTION METHODS AND SYSTEMS” filed on Feb. 15, 2006, the contents of which are incorporated herein by reference. In addition, the present invention is related to commonly assigned, co-pending U.S. patent application Ser. No. 10/918,467 to Normand St. Pierre entitled “PROCESS, SYSTEM AND METHOD FOR IMPROVING THE DETERMINATION OF DIGESTIVE EFFECTS UPON AN INGESTABLE SUBSTANCE” filed on Aug. 16, 2004, which is incorporated fully herein by reference.

### FIELD OF THE INVENTION

The present invention relates to the field of agriculture and, more particularly, to methods and systems for blending ingredients including low quality blood meal and high quality blood meal to produce feed for ruminants.

### BACKGROUND OF THE INVENTION

The digestive process of ruminants (e.g., cows) is an important consideration to many aspects of modern agriculture. A major economic concern in dairy farming is the conversion of feed consumed by ruminants to milk and the price of the feed.

Desired levels of nutrients within feed have been identified that are believed to optimize the conversion of the feed into desired milk and milk components, e.g., milk fat and milk protein. Deviation from the desired levels of nutrients, too high and/or too low, may adversely affect the desired end products and/or have an undesirable environmental impact. For example, a level of metabolizable protein that is too low may lower the volume of milk produced by a ruminant. An imbalance in the amino acid content of the feed may lower the fat or protein content of the milk produced by a ruminant, which decreases the market value of the milk. A level of metabolizable protein that is too high may result in increased levels of excrement requiring disposal.

Ingredients for use in ruminant feed that provide one or more of the desired nutrients at consistent and high levels are typically more expensive than ingredients that do not provide a high level of the desired nutrients and/or have erratic levels of those nutrients. Thus, producing feed having desired levels of nutrients using ingredients having consistent high levels of nutrients may cost substantially more than feed produced using ingredients having low and/or erratic levels of nutrients.

### SUMMARY OF THE INVENTION

The present invention is embodied in methods, systems, and computer readable media including steps to configure a computer. In accordance with aspects of the present invention, a method, system, and computer readable media including steps to configure a computer are described for use in producing feed for a ruminant where the ruminant feed has a minimum metabolizable nutrient level for at least one nutrient, e.g., protein. Steps used in producing the ruminant feed include determining a metabolizable nutrient level in a low quality blood meal and determining a quantity of low quality blood meal for blending with a quantity of a high quality blood meal having a second metabolizable nutrient level to produce the ruminant feed having the minimum metabolizable nutrient level.

In accordance with other aspects of the present invention, alternative methods including steps for use in producing feed for a ruminant where the ruminant feed has a minimum metabolizable protein (MP) level and a minimum metabolizable lysine (ML) level. Steps used in producing the ruminant feed include determining a first MP level and a first ML level in a low quality blood meal and determining a first quantity of the low quality blood meal for blending with a second quantity of a high quality blood meal having a second MP level and a second ML level to produce the ruminant feed having the minimum MP level and the minimum ML level based at least in part on the determined first MP and ML levels and on the second MP and ML levels.

In accordance with other aspects of the present invention, alternative methods including steps for producing feed for a ruminant where the ruminant feed has a minimum metabolizable nutrient level for at least one nutrient. The ruminant feed is produced by determining a first metabolizable nutrient level for each of the at least one nutrient in a low quality blood meal, determining a first quantity of the low quality blood meal for blending with a second quantity of a high quality blood meal having a second metabolizable nutrient level for the at least one nutrient to produce the ruminant feed having the minimum metabolizable nutrient level for the at least one nutrient based at least in part on the determined first metabolizable nutrient level and on the second metabolizable nutrient level for the at least one nutrient, and blending the first quantity of the low quality blood meal and the second quantity of the high quality blood meal to produce the ruminant feed.

### BRIEF DESCRIPTION OF THE DRAWINGS

The invention is best understood from the following detailed description when read in connection with the accompanying drawings. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Also, lines without arrows connecting components may represent a bidirectional exchange between these components. Included in the drawings are the following figures:

FIG. 1 is a schematic illustration of an exemplary ruminant feed production system in accordance with an aspect of the present invention.

FIG. 2 is a flow chart of exemplary steps for producing ruminant feed in accordance with an aspect of the present invention;

FIG. 2A is a flow chart of exemplary steps for determining nutrient levels for use in the exemplary steps of FIG. 2; and

FIG. 3 is a flow chart of exemplary steps for blending ruminant feed in accordance with an aspect of the present invention.

### DETAILED DESCRIPTION OF THE INVENTION

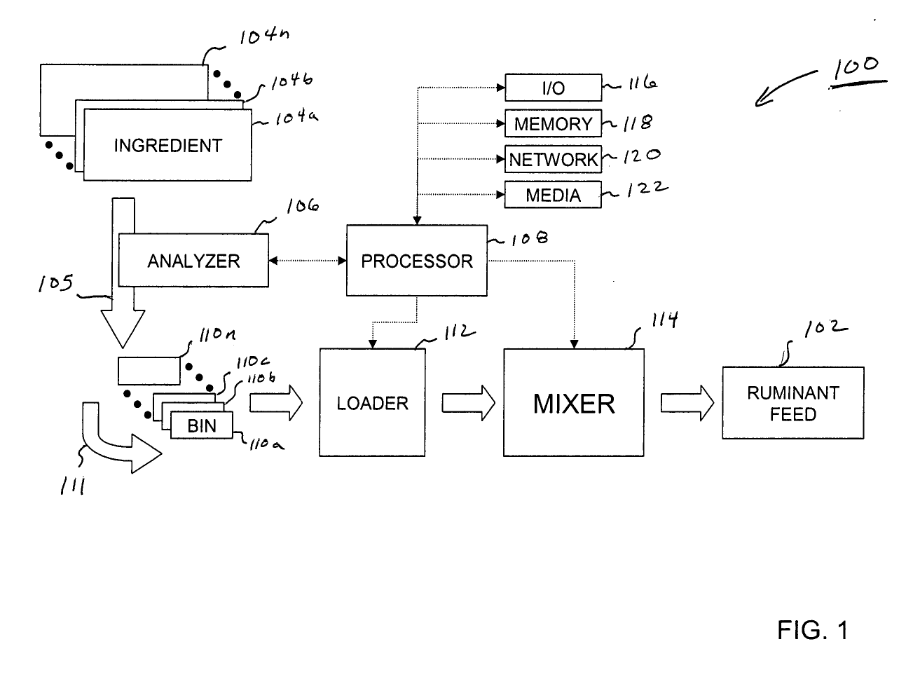

FIG. 1 depicts an exemplary ruminant feed production system 100 for producing feed 102 for a ruminant, e.g., cows, from a plurality of ingredients 104a-n. In an exemplary embodiment, the ingredients 104 include feather meal, a low quality blood meal, a high quality blood meal, and a binding/free flow agent such as bentonite. The low quality blood meal may be a commodity blood meal such as ring dried blood meal and the high quality blood meal may be spray dried blood meal. In an alternative exemplary embodiment, the ingredients 104 may further include a source of methionine such as hydroxy methyl butanoic acid (HMB) and/or a source of synthetic metabolizable methionine (SMM). Suitable HMB and SMM for use with the present invention are Rhodimet™ AT 88 and Smartamine™, respectively, available from Adisseo USA Inc., Alpharetta, Ga., USA. Smartamine SMM is a source of “protected” methionine, meaning that substantially all of the methionine ingested in this form reaches the small intestine of a cow where it is absorbed into the blood stream, which is desirable to improve the yield, fat content, and protein content of the milk produced by the cow. Suitable feather meals, blood meals, and binding/free flow agents will be understood by one of skill in the art from the description herein.

An analyzer 106 is used to analyze one or more of the ingredients 104 to determine one or more characteristic values of the ingredients 104 including a metabolizable nutrient level for at least one nutrient. In an exemplary embodiment, the analyzer 106 analyzes low quality blood meal to determine characteristic values including crude protein level, metabolizable protein (MP) level, and metabolizable lysine (ML) level. The analyzer 106 is illustrated as partially covering block arrow 105 to represent that some ingredients 104 may not be analyzed. For example, high quality blood meal has very little nutrient level fluctuation and, thus, may not need to be analyzed.

The analyzer 106 may include a near infrared reflectance spectroscopy (NIRS) analyzer that obtains a NIRS spectrum/signature for a sample of an ingredient being analyzed for the estimation of nutrient levels based on multivariate calibration curves/equations derived using NIRS spectra of samples with known nutrient compositions. Prior to determining the NIRS signature of the sample, the NIRS signatures of samples with corrected values may be determined. Using multiple regression techniques, an equation relating the amount reflected at each wavelength of the spectrum to the amount of each corrected value may be determined. These equations may then be digitally stored by the NIRS analyzer 106 for use in determining the levels of the corrected values for the sample from the NIRS signature of the sample. This method of calibrating a NIRS analyzer to determine the value of a corrected characteristic in a sample will be understood by one of skill in the art from the description herein. The corrected values may be determined using the technique described in U.S. patent application Ser. No. 10/918,467. A suitable NIRS analyzer is a FOSS NIRSystems/Tecator available from Infrasoft International LLC, Laurel, Md., USA.

In an exemplary embodiment, one or more of the corrected characteristic values associated with the stored NIRS signatures are generated using techniques described in commonly assigned, co-pending U.S. patent application Ser. No. 10/918,467 to Normand St. Pierre entitled “PROCESS, SYSTEM AND METHOD FOR IMPROVING THE DETERMINATION OF DIGESTIVE EFFECTS UPON AN INGESTABLE SUBSTANCE” filed on Aug. 16, 2004, which is incorporated fully herein by reference. This technique is especially useful for determining metabolizable nutrient levels such as MP and ML levels in ingredients such as blood meal with a high level of accuracy.

The processor 108 determines the quantities of one or more of the ingredients 104 to produce ruminant feed 102 having desired characteristics based on the ingredients 104 and the characteristics of those ingredients 104. In an exemplary embodiment, the processor 108 utilizes feed formulation software to determine the quantities of one or more of the ingredients 104. Exemplary feed formulation software includes Brill Formulation available from Brilliant Alternatives, Inc., Spotsylvania, Va., USA and Concept5 available from Creative Formulation Concepts, LLC (formerly Agri-Data), Annapolis, Md., USA. One or more of the ingredients 104 may be added in fixed quantities with the feed formulation software calculating the quantities of the other ingredients. For example, the amount of bentonite may be fixed at 40 lbs per ton of feed 102.

The processor 108 may receive the desired characteristics, ingredients 104, and characteristics of the ingredients 104 via an input/output (I/O) device 116 coupled to the processor 108. The desired characteristics of the ruminant feed 102, ingredients 104, and characteristics of the ingredients 104 may be supplied manually via a manual I/O device 116 such as a keyboard and/or mouse. Alternatively, one or more of the desired characteristics, ingredients 104, and/or ingredient characteristics may be received electronically from another device or may be stored in the memory 118. For example, characteristics of an analyzed ingredient 104 may be supplied directly by the analyzer 106 and characteristics for an ingredient 104 that is commonly used may be automatically retrieved from the memory 118 when that ingredient is input via the I/O device 116. The processor 108 may be coupled to a network 120 and/or configured to receive instructions from removable media 122 such as a compact disc (CD), digital versatile disc (DVD), or other media capable of storing information.

In an exemplary embodiment, one or more of the ingredients 104 are loaded into bins 110a-n. The bins 110 may include dry storage bins for storing dry ingredients such as feather meal and blood meal and liquid storage bins (e.g., storage tanks) for storing liquid ingredients such as HMB. Separate bins may be utilized for a particular ingredient with different nutrient levels. For example, blood meal may be stored in different bins based on its MP value, ML value, and/or crude protein level. Block arrow 111 is used to indicate that some ingredients may not be stored in bins 110. For example, bentonite and SMM may be stored in a bag and/or box in which they are received from a supplier.

A loader 112 loads the ingredients 104 into a mixer 114. The loader 112 may include a system of augers that transport ingredients 104 from the bins 110 into the mixer 114. The loader 112 may further include tubes (not shown) for transporting liquids such at HMB from a storage tank (not shown) into the mixer 114. One or more ingredients 104 may be manually added directly into the loader 112 for addition to the mixer 114. For example, bentonite and SMM may be manually added to an auger leading into the mixer 114. The loader 112 may be manually controlled and/or controlled by the processor 108. A suitable mixer 114 for mixing the ingredients and a suitable method of loading the mixer 114 will be understood by one of skill in the art from the description herein.

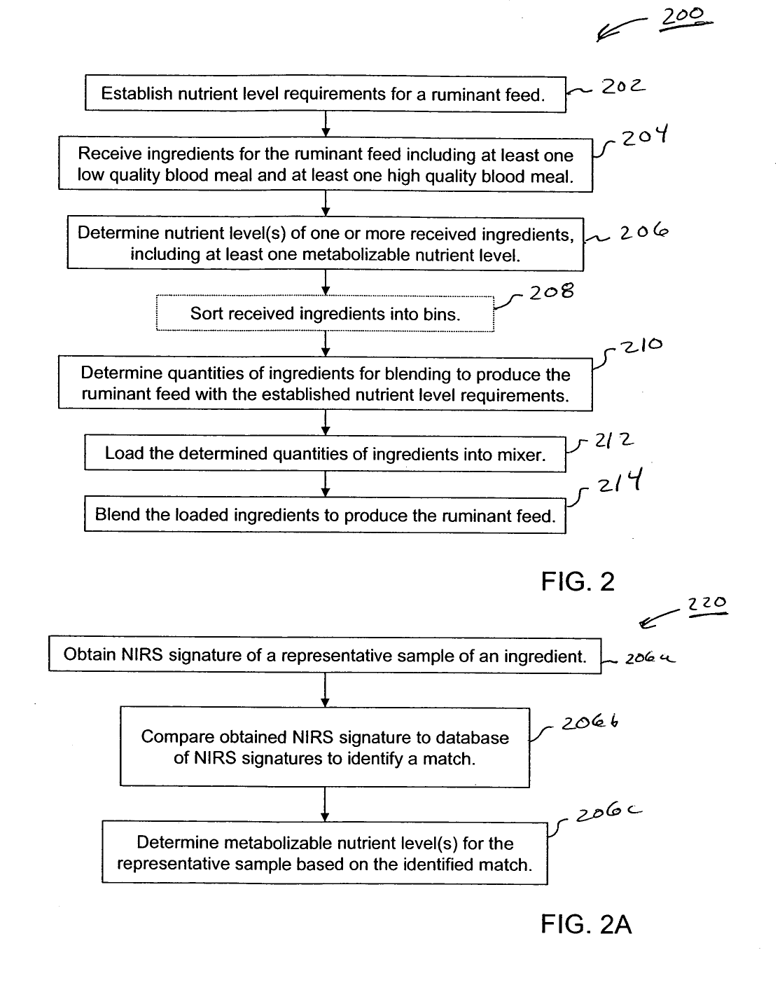

FIG. 2 depicts a flow chart 200 of exemplary steps for producing ruminant feed. The exemplary steps of the flow chart 200 are described below with reference to FIG. 1.

At block 202, desired nutrient level requirements are established for the ruminant feed 102. In an exemplary embodiment, the ruminant feed has a minimum metabolizable nutrient level for at least one nutrient, e.g., protein. It will be understood by one of skill in the art that the types of nutrients and the required levels may vary widely depending on the desired characteristics. For example, one set of characteristics may be used to produce feed that enhances milk production and another set of characteristics may be used to produce feed that enhances weight gain. In an exemplary embodiment, the desired nutrient level requirements include a crude protein level of at least about 84%, a MP level of at least about 54%, and a ML level of at least about 4.5%. Crude protein represents the total amount of protein for consumption by a ruminant and MP represents the portion of the crude protein that is absorbed in the lower intestines of the ruminant.

At block 204, ingredients 104 are received. In an exemplary embodiment, the received ingredients include feather meal, low quality blood meal, high quality blood meal, and a binding/free flow agent such as bentonite. In alternative exemplary embodiments, the received ingredients may further include HMB and/or SMM. The feather meal, the low quality blood meal, and the high quality blood meal may each be received in truck loads and/or train car loads (herein “loads”). The HMB may be received in 6,000 gallon tanker trailer loads, the bentonite may be received in 50 lb bags, and the SMM may be received in 55 lb boxes.

At block 206, nutrient levels for each of at least one nutrient in one or more of the ingredients are determined. In an exemplary embodiment, the determined nutrient levels include at least one metabolizable nutrient level, e.g., an MP value, in the low quality blood meal. Additionally, an ML value and a crude protein value may be determined in the low quality blood meal. In an exemplary embodiment, the MP value, ML value, and crude protein value of the low quality blood meal are determined for every load of the low quality blood meal in accordance with the exemplary steps described below with reference to FIG. 2A.

The determined nutrients levels may further include nutrient levels for the high quality blood meal, feather meal, HMB, and SMM. Nutrient levels for these ingredients may be determined periodically. For example, spray dried blood meal consistently has a crude protein level of 92.5%, an MP level of 76%, and an ML level of 7.5% and, thus, when spray dried blood meal is used as the high quality blood meal, the level of these nutrients do not need to be determined for every load. Also, feather meal typically has consistent crude protein levels, protein digestibility, and fat content based on supplier and, thus, feather meal from the same supplier may be checked only periodically. In an exemplary embodiment, the feather meal used to produce the ruminant feed consistently has a crude protein level of 82%, an MP level of 25%, and an ML level of 0.5%. Nutrient levels for HMB and SMM, such as metabolizable methionine (MM) are typically very consistent and may be determined based on representations of the manufacturer.

At block 208, one or more of the received ingredients are sorted into bins 110. In an exemplary embodiment, the feather meal, low quality blood meal, and high quality blood meal are stored in bins based on their nutrient levels. In an exemplary embodiment, minimum characteristic values are established for the feather meal and the low quality blood meal with only feather meal and blood meal exceeding these minimum characteristics being deposited into bins 110 from which the feather meal and low quality blood meal are drawn. In an exemplary embodiment, low quality blood meal has a minimum MP of about 47%, a minimum ML of about 3.8% and a minimum crude protein of about 87%. Feather meal and low quality blood meal failing to meet the minimum requirements may be used to produce feed for livestock other than the ruminant feed 102 having the desired characteristics.

At block 210, quantities of ingredients 104 for blending to produce a batch of ruminant feed 102 are determined. In an exemplary embodiment, the processor 108 determines the quantities of the ingredients 104 using feed formulation software. The feed formulation software may determine a first quantity of low quality blood meal to blend with a second quantity of high quality blood meal, e.g., based on their respective nutrient levels. For example, the feed formulation software may determine the quantities of low quality blood meal and high quality blood meal based on their respective MP levels. Additionally, the quantities may be determined based on the respective ML levels and/or crude protein levels of the blood meals. Furthermore, the feed formulation software may take into account other ingredients such as feather meal, HMB, and SMM and their respective nutrient levels. For example, feather meal, HMB, and SMM may contribute important nutrients in addition to crude protein, MP, and ML (e.g., protected methionine) that may or may not be accounted for by the feed formulation software. In such cases the desired inclusion level of feather meal, HMB, and SMM may be a fixed amount not determined by processor 108. The feed formulation software, however, may take the weight and contribution of these fixed level ingredients into account when calculating the amounts of the other ingredients.

In an exemplary embodiment, the feed formulation software is configured to produce 2,000 lbs of ruminant feed 102 in each batch. One or more of the ingredients 104 may have a fixed quantity. In an exemplary embodiment, the bentonite is fixed at about 40 lbs. In an alternative exemplary embodiment, the HMB is additionally fixed at about 72 lbs. In other alternative exemplary embodiments, the SMM is further additionally fixed at about 35 lbs or 55 lbs. When fixed quantities of the ingredients 104 are used, the feed formulation software accommodates for the fixed quantities of ingredients 104 in determining quantities of the other ingredients, e.g., feather meal, low quality blood meal, and high quality blood meal. Typically, the quantities of these ingredients used in the production of 2,000 lbs of ruminant feed 104 are 300-400 lbs feather meal, 600-900 lbs low quality blood meal, and 600-900 lbs high quality blood meal with the low quality blood meal and high quality blood meal together weighing about 1,500 lbs.

At block 212, the determined quantities of ingredients 104 are loaded into the mixer 114. In an exemplary embodiment, the feather meal, low quality blood meal, and the high quality blood meal are augered from their respective bins 110 into the mixer 114. In addition, the HMB, if used, is pumped into the mixer 114 from a bin 110 such as a storage tank. Further, the SMM, if used, may be manually added into the mixer 114, e.g., by dumping the SMM into an auger leading into the mixer 114. The bentonite may be added in a manner similar to the SMM.

At block 214, the mixer 114 blends the loaded ingredients. The mixer 114 may blend the ingredients as they are loaded into the mixer 114 and, thus, the steps of blocks 212 and 214 may overlap. The blending may be controlled manually or automatically, e.g., via the processor 108.

FIG. 2A depicts a flow chart 220 of exemplary steps for determining nutrient levels, such as metabolizable nutrient levels, in one or more of the ingredients, e.g., in the low quality blood meal.

At block 206a, a NIRS spectrum/signature is obtained of an ingredient, e.g., low quality blood meal. In an exemplary embodiment, a representative sample from a load of the ingredient is gathered and the analyzer 106 obtains a NIRS signature (herein “analyzed NIRS signature”) of the representative sample. A representative sample may be obtained by gathering small quantities of the ingredient from multiple locations within a load and combining the gathered ingredients.

At block 206b, the analyzed NIRS signature of the ingredient is compared to multivariate calibration curves associated with corrected nutrient levels. The multivariate calibration curves may be derived in a known manner using NIRS spectra associated with corrected nutrient levels and the NIRS signature may be compared to the multivariate calibration curves in a conventional manner. In an exemplary embodiment, the characteristics of the ingredient include at least one corrected metabolizable nutrient level. For example, blood meal characteristics may include a corrected MP value, a corrected ML value, and a crude protein value. In an exemplary embodiment, the corrected nutrient levels used to derive the multivariate curves are determined using the techniques described in U.S. patent application Ser. No. 10/918,467.

At block 206c, the nutrient level(s) is/are determined for the representative sample and, thus, the ingredient 104. In an exemplary embodiment, the determined nutrient levels are based on the comparison of the analyzed NIRS signature of the ingredient to the multivariate calibration curves in the step of block 206b. In an exemplary embodiment, the determined nutrient levels include at least one metabolizable nutrient level. For example, an MP level, an ML level, and a crude protein level may be determined for a representative sample of low quality blood meal.

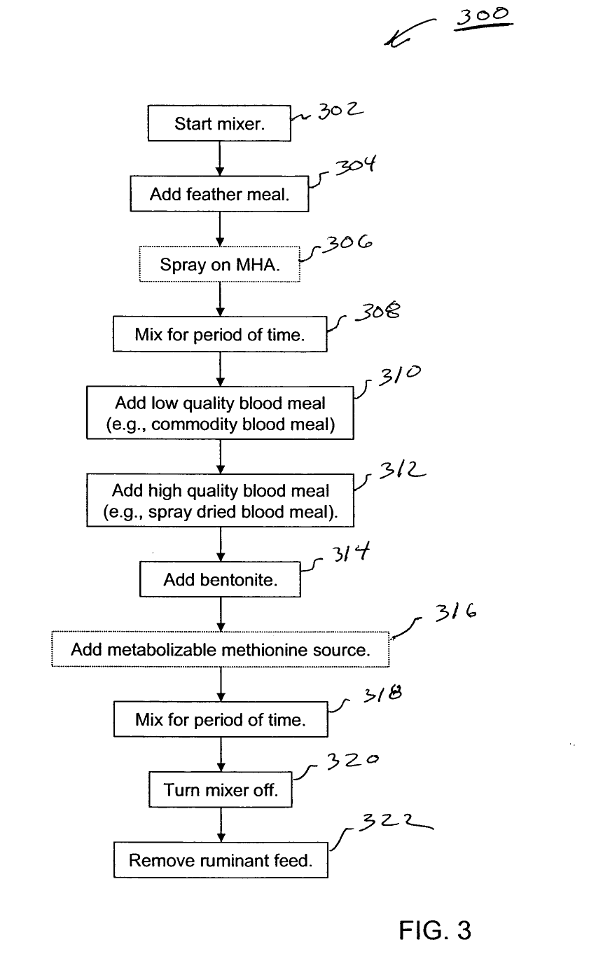

FIG. 3 depicts a flow chart 300 of exemplary steps for blending ingredients to produce ruminant feed. The exemplary steps are described with reference to FIG. 1.

At block 302, the mixer 114 starts and feather meal is added to the mixer 114 at block 304. In an exemplary embodiment, the loader 112 augers feather meal from a bin 110 in which the feather meal is stored into the mixer 114 in an amount determined by the feed formulation software. The feather meal may be added as a mixing agent/carrier for HMB, and/or as a methyl donor and/or as part of the total sulfur amino acid supply to reduce the amount of metabolizable methionine required from SMM.

Optionally, at block 306, HMB is added to the mixer 114. In an exemplary embodiment, a specified quantity of the HMB, e.g., approximately 72 lbs, is retrieved from a storage tank and sprayed onto the feather meal within the mixer 114.

At block 308, the feather meal and the optional HMB is mixed for a period of time. In an exemplary embodiment, the period of time is about one to five minutes.

At block 310, low quality blood meal is added to the mixer 114. In an exemplary embodiment, the loader 112 augers the low quality blood meal from an appropriate bin 110 into the mixer 114 in an amount determined by the feed formulation software described above. The bin 110 from which the low quality blood meal is augered is the bin 110 including low quality blood meal having the characteristics used by the feed formulation software.

At block 312, high quality blood meal is added to the mixer 114. In an exemplary embodiment, the loader 112 augers the high quality blood meal from an appropriate bin into the mixer 114 in an amount determined by the feed formulation software described above.

At block 314, bentonite is added to the mixer 114. In an exemplary embodiment, bentonite is added to the mixer 114 by adding a fixed quantity of bentonite, e.g., approximately 40 lbs, to an auger leading into the mixer 114.

Optionally, at block 316, MMS is added to the mixer 114. In an exemplary embodiment, MMS is added to the mixer 114 by adding a fixed quantity of MMS, e.g., between about 30 lbs and about 60 lbs, to an auger leading into the mixer 114.

At block 318, the mixer 114 mixes the ingredients added in steps 304-316 for a period of time, e.g., one to five minutes, and, at step 320, the mixer 114 is turned off. The resultant ruminant feed 102 is then removed from the mixer 114 at block 322 for packaging and/or distribution.

It will be understood by one of skill in the art that the exemplary steps described above with reference to FIG. 3 may be carried out manually and/or under control of the processor 108.

In accordance with an exemplary aspect of the present invention, low quality blood meal may be utilized to obtain ruminant feed having desired consistent characteristics even though low quality blood meal may have erratic levels of nutrients such as MP, ML, and crude protein. The techniques for determining corrected nutrient levels described in commonly assigned, co-pending U.S. patent application Ser. No. 10/918,467 to Normand St. Pierre entitled “PROCESS, SYSTEM AND METHOD FOR IMPROVING THE DETERMINATION OF DIGESTIVE EFFECTS UPON AN INGESTABLE SUBSTANCE” filed on Aug. 16, 2004, which is incorporated fully herein by reference, enable the creation of a database against which loads of low quality blood meal may be compared to accurately determine the nutrient levels of each load of low quality blood meal. The low quality blood meal can then be blended with the other ingredients, including high quality blood meal, in quantities determined by feed formulation software to obtain the ruminant feed having the desired consistent characteristics.

It is contemplated that one or more of the steps described above with reference to FIGS. 2, 2A, and 3 may be implemented in software on a computer such as processor 108. In this embodiment, one or more steps may be implemented in software that controls the computer. This software may be embodied in a computer readable media 122 (FIG. 1), for example, a magnetic or optical disk, a memory-card or an audio frequency, radio-frequency, or optical carrier wave.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for use in producing feed for a ruminant, the ruminant feed having a minimum metabolizable nutrient level for at least one nutrient, the method comprising the steps of:
determining a first metabolizable nutrient level for each of the at least one nutrient in a low quality blood meal; and
determining a first quantity of the low quality blood meal for blending with a second quantity of a high quality blood meal having a second metabolizable nutrient level for the at least one nutrient to produce the ruminant feed having the minimum metabolizable nutrient level for the at least one nutrient based at least in part on the determined first metabolizable nutrient level and on the second metabolizable nutrient level for the at least one nutrient.

2. The method of claim 1, further comprising the step of:
determining the second metabolizable nutrient level for the at least one nutrient in the high quality blood meal.

3. The method of claim 1, wherein the at least one nutrient includes protein and wherein the step of determining the first metabolizable nutrient level comprises the step of:
determining a metabolizable protein level.

4. The method of claim 1, wherein the at least one nutrient includes lysine and wherein the step of determining the first metabolizable nutrient level comprises the step of:
determining a metabolizable lysine level.

5. The method of claim 1, wherein the at least one nutrient includes lysine and protein and wherein the step of determining the first metabolizable nutrient level comprises the steps of:
determining a metabolizable protein level; and
determining a metabolizable lysine level.

6. The method of claim 5, wherein the ruminant feed further has a minimum crude protein level and wherein the method further comprises the step of:
determining a crude protein level in the low quality blood meal; and
wherein the step of determining the first quantity of low quality blood meal for blending with a second quantity of high quality blood meal is further based on the determined crude protein level.

7. The method of claim 1, wherein the low quality blood meals is commodity blood meal.

8. The method of claim 7, wherein the commodity blood meal is ring dried blood meal.

9. The method of claim 1, wherein the high quality blood meal is spray dried blood meal.

10. The method of claim 1, wherein the step of determining the first metabolizable nutrient level for the low quality blood meal comprises the steps of:
obtaining a near infrared reflectance spectroscopy (NIRS) signature of a sample of the low quality blood meal;
comparing the NIRS signature of the representative sample to a plurality of calibration curves within a database associated with corrected nutrient levels; and
determining the first metabolizable nutrient level for each of the at least one nutrient based on the comparison of the NIRS signature to the plurality of calibration curves.

11. The method of claim 1, wherein the step of determining the first quantity of the low quality blood meal for blending with the second quantity of the high quality blood meal further includes:
determining quantities of at least one other ingredient for blending with the low quality blood meal and with the high quality blood meal;
wherein the quantities of the low quality blood meal, the high quality blood meal, and the at least one other ingredient are based on characteristics of the low quality blood meal, the high quality blood meal, and the at least one other ingredient.

12. The method of claim 11, wherein the at least one other ingredient includes one or more ingredients selected from a group consisting of feather meal, hydroxy methyl butanoic acid (HMB), and synthetic metabolizable methionine (SMM).

13. The method of claim 12, wherein the at least one other ingredient further includes bentonite.

14. A method for use in producing feed for a ruminant, the ruminant feed having a minimum metabolizable protein (MP) level and a minimum metabolizable lysine (ML) level, the method comprising the steps of:
determining a first MP level and a first ML level in a low quality blood meal; and
determining a first quantity of the low quality blood meal for blending with a second quantity of a high quality blood meal having a second MP level and a second ML level to produce the ruminant feed having the minimum MP level and the minimum ML level based at least in part on the determined first MP and ML levels and on the second MP and ML levels.

15. The method of claim 14, further comprising the step of:
determining the second MP level and the second ML level for the high quality blood meal.

16. The method of claim 14, wherein the ruminant feed further has a minimum crude protein level and wherein the method further comprises the step of:
determining a crude protein level in the low quality blood meal; and
wherein the step of determining the first quantity of low quality blood meal for blending with a second quantity of high quality blood meal is further based on the determined crude protein level.

17. The method of claim 14, wherein the low quality blood meals is commodity blood meal.

18. The method of claim 17, wherein the commodity blood meal is ring dried blood meal.

19. The method of claim 14, wherein the high quality blood meal is spray dried blood meal.

20. The method of claim 14, wherein the step of determining the first MP and ML levels for the low quality blood meal comprises the steps of:
obtaining a near infrared reflectance spectroscopy (NIRS) signature of a sample of the low quality blood meal;
comparing the NIRS signature of the representative sample to calibration curves within a database, the calibration curves associated with corrected MP and ML levels; and
determining the first MP and ML levels based on the comparison of the NIRS signature to the calibration curves.

21. The method of claim 14, wherein the step of determining the first quantity of the low quality blood meal for blending with the second quantity of the high quality blood meal further includes:
determining quantities of at least one other ingredient for blending with the low quality blood meal and with the high quality blood meal;
wherein the quantities of the low quality blood meal, the high quality blood meal, and the at least one other ingredient are based on characteristics of the low quality blood meal, the high quality blood meal, and the at least one other ingredient.

22. The method of claim 21, wherein the at least one other ingredient includes one or more ingredients selected from a group consisting of feather meal, hydroxy methyl butanoic acid (HMB), and synthetic metabolizable methionine (SMM).

23. The method of claim 22, wherein the at least one other ingredient further includes bentonite.

24. A method for producing feed for a ruminant, the ruminant feed having a minimum metabolizable nutrient level for at least one nutrient, the method comprising the steps of:
determining a first metabolizable nutrient level for each of the at least one nutrient in a low quality blood meal;
determining a first quantity of the low quality blood meal for blending with a second quantity of a high quality blood meal having a second metabolizable nutrient level for the at least one nutrient to produce the ruminant feed having the minimum metabolizable nutrient level for the at least one nutrient based at least in part on the determined first metabolizable nutrient level and on the second metabolizable nutrient level for the at least one nutrient; and
blending the first quantity of the low quality blood meal and the second quantity of the high quality blood meal to produce the ruminant feed.

25. The method of claim 24, further comprising the step of:
determining the second metabolizable nutrient level for the at least one nutrient in the high quality blood meal.

26. The method of claim 24, wherein the at least one nutrient includes protein and wherein the step of determining the first metabolizable nutrient level comprises the step of:
determining a metabolizable protein level.

27. The method of claim 24, wherein the at least one nutrient includes lysine and wherein the step of determining the first metabolizable nutrient level comprises the step of:
determining a metabolizable lysine level.

28. The method of claim 24, wherein the at least one nutrient includes lysine and protein and wherein the step of determining the first metabolizable nutrient level comprises the steps of:
determining a metabolizable protein level; and
determining a metabolizable lysine level.

29. The method of claim 24, wherein the ruminant feed further has a minimum crude protein level and wherein the method further comprises the step of:
determining a crude protein level in the low quality blood meal; and
wherein the step of determining the first quantity of low quality blood meal for blending with a second quantity of high quality blood meal is further based on the determined crude protein level.

30. The method of claim 24, wherein the low quality blood meals is commodity blood meal.

31. The method of claim 30, wherein the commodity blood meal is ring dried blood meal.

32. The method of claim 24, wherein the high quality blood meal is spray dried blood meal.

33. The method of claim 24, wherein the step of determining the first metabolizable nutrient level for the low quality blood meal comprises the steps of:
obtaining a near infrared reflectance spectroscopy (NIRS) signature of a sample of the low quality blood meal;
comparing the NIRS signature of the representative sample to a plurality of calibration curves within a database associated with corrected nutrient levels; and
determining the first metabolizable nutrient level for each of the at least one nutrient based on the comparison of the NIRS signature to the plurality of calibration curves.

34. The method of claim 24, wherein the step of determining the first quantity of the low quality blood meal for blending with the second quantity of the high quality blood meal further includes:
determining quantities of at least one other ingredient for blending with the low quality blood meal and with the high quality blood meal;
wherein the quantities of the low quality blood meal, the high quality blood meal, and the at least one other ingredient are based on characteristics of the low quality blood meal, the high quality blood meal, and the at least one other ingredient.

35. The method of claim 34, wherein the blending step comprises the step of:
blending the determined quantities of the low quality blood meal, the high quality blood meal, and the at least one other ingredient to produce the ruminant feed.

36. The method of claim 35, wherein the at least one other ingredient includes one or more ingredients selected from a group consisting of feather meal, hydroxy methyl butanoic acid (HMB), and synthetic metabolizable methionine.

37. The method of claim 36, wherein the at least one other ingredient further includes bentonite.

38. A computer readable media including instructions for configuring a computer to implement a method for producing feed for a ruminant, the method comprising the steps of:
determining a first metabolizable nutrient level for each of the at least one nutrient in a low quality blood meal; and
determining a first quantity of the low quality blood meal for blending with a second quantity of a high quality blood meal having a second metabolizable nutrient level for the at least one nutrient to produce the ruminant feed having the minimum metabolizable nutrient level for the at least one nutrient based at least in part on the determined first metabolizable nutrient level and on the second metabolizable nutrient level for the at least one nutrient.

39. A system for use in producing feed for a ruminant, the ruminant feed having a minimum metabolizable nutrient level for at least one nutrient, the system comprising:
means for determining a first metabolizable nutrient level for each of the at least one nutrient in a low quality blood meal; and
means for determining a first quantity of the low quality blood meal for blending with a second quantity of a high quality blood meal having a second metabolizable nutrient level for the at least one nutrient to produce the ruminant feed having the minimum metabolizable nutrient level for the at least one nutrient based at least in part on the determined first metabolizable nutrient level and on the second metabolizable nutrient level for the at least one nutrient.
